(19) United States
(12) Patent Application Publication
(10) Pub. No.: US 2007/0180875 A1
(43) Pub. Date: Aug. 9, 2007

(54) Combination tool

(76) Inventor: Joseph Byrne, Anaheim, CA (US)

Correspondence Address: AVERILL & VARN, 8244 PAINTER AVE., WHITTIER, CA, 90602, US

(21) Appl. No.: 11/346,941

(22) Filed: Feb. 3, 2006

(51) Int. Cl. E05B 19/14

(52) U.S. Cl. 70/401

(57) ABSTRACT

A combination tool includes a compact “D” shaped handle and a rotating drum for tool selection. The straight back segment of the “D” provides an axis for rotation of the drum. The drum includes opposed tool ends, either of which may be rotated into position for use. In a preferred embodiment, the tool ends are keys for releasing a tamper resistant cap over a Schrader valve. Each key is shaped for a cap used with a particular Freon® refrigerant used in an air conditioning unit. The drum includes indicia of which Freon® refrigerant the corresponding key matches.

### BACKGROUND OF THE INVENTION

The present invention relates to tools for releasing locks and in particular to a tool for releasing a cap lock assembly residing on a threaded cylindrical end of an access or security device, such as a Schrader valve.

A Schrader valve is generally used for adding Freon to air conditioning units. Schrader valves include a center pin held closed by a spring, and after removing a simple valve cap, the center pin may easily be depressed to release any pressurized gases contained in the system. Schrader valves are commonly used for adding and removing air from automobile and bicycle tires, and other pneumatic devices. The valve caps serve to cover and protect the center pin from damage, but do not prevent unauthorized access to the valve.

An alarming trend in substance abuse has emerged where children inhale Freon® refrigerant gases taken from air conditioning units. They do so to get a “high,” but often become ill and even die in extreme cases. Unfortunately, it is very easy for children to remove the simple cap, depress the center pin, and release Freon® from air conditioning units.

Various protective cap devices have been developed to deter similar unauthorized access by children to containers containing medicine and other potential poisons. Many of these child tamper resistant caps require only that the cap be depressed slightly or squeezed while rotating the cap. Other similar caps require the use of a key to effect release, which in some cases either has an overly complicated cap removal due to a multitude of moving parts, or is arguably too simple and therefore easily bypassed by children.

For example, in U.S. Pat. No. 3,426,932, a tamper-proof poison bottle closure is shown having an inner cap 14 capable of threadedly securing to a threaded neck 10 of a bottle and enclosed by an outer cap 32. A torque may be exerted on the inner cap for opening and closing, by using a key 43 to turn a threaded disklike collar 52 positioned within the outer cap and above the inner cap. Rotation of the collar produces rack-and-pinion actuation of a pair of block-like slides 60 slidably held on vertical tracks 62 along the inner surface of the outer cap. In this manner, and as shown in FIG. 2 of the '932 patent, the block-like slides engage a rib 40 along the top of the inner cap to unscrew the inner cap upon rotation of the outer cap. While this prior art bottle closure serves to restrict access, the many moving components of its rack-and-pinion mechanism may be overly complicated and economically burdensome for mass production.

Additionally, in U.S. Pat. No. 6,032,811, another childproof cap assembly is shown having an inner cap 11 and enclosed by an outer cap 3. Both the outer cap and inner cap each have respective key slots 6 and 14 which are adapted to receive a key 7. Additionally, the inner cap has an alignment mark 15, and the outer cap has an alignment aperture 16 for assisting a user in aligning the key slots. Upon successful alignment, the key may be inserted through the slots and subsequently rotated to unscrew the inner cap from the container. One of the disadvantages of this prior art cap is that the key itself is attached to and kept together with the cap. Moreover, the slot engagement and operation of the inner cap may be easily manipulated with readily available tools, such as a screwdriver.

In U.S. Pat. No. 738,917, a bottle stopper is shown having a threaded inner shell for threadedly engaging a neck portion of a bottle, and an outer capsule which encloses the inner shell. The inner shell has a pair of studs 16, 17 extending above a transverse cap portion 4 of the inner shell. A key including a pair of radial webs 24 is inserted though a key-receiving perforation 11 and engaged with the studs to directly exert a torque on the studs. Operation of this prior art cap lock is simple, straightforward, and intuitive, therefore presenting little difficulty for children having access to the key. Further, insertion of a straight shaft diagonally into the lock may engage the studs 16,17 and allow removal of the cap without the key.

An unrelated problem has arisen from the use of a single size of Schrader valve for feeding different refrigerants, such as those sold under the trademarks “Freon R22,” “Freon R410,” and “Freon R12.” These different refrigerant gases are not compatible. A careless service person could easily feed the wrong refrigerant gas into the Schrader valve, since all systems use the same valve. It would thus, be useful to provide a key which will only open a lock for one composition of refrigerant gas to help eliminate this potential mistake.

These needs, and others, were addressed by U.S. Pat. No. 6,612,455 for a “Cap Lock Assembly and System,” filed by the inventor of the present invention. The '455 patent describes a unique lock assembly and key system for restricting access or operation to a rotationally operated cap, cover, switch, or the like, for example, a threadedly attached cap on a Schrader valve. In the case of a threaded cap or cover, an inner lock 25 has a threaded cavity 34 which screws onto an externally-threaded cylindrical end of, for example, the Schrader valve 11. The open end of an outer cap 15 fits over the inner lock 25 thereby captively enclosing the inner lock 25 in a manner which allows free rotation between the inner lock 25 and outer cap 15 thus preventing the inner lock 25 from being unscrewed. An upper end wall 16 of the outer cap 15 has a keyhole 23 leading into a recessed cavity 26 of the inner lock 25, with the recessed cavity 26 surrounded by an annular wall. A key 37 is provided for locking and unlocking the inner lock 25 from the Schrader valve 11. The key 37 has a pivot shaft 41 which is matingly insertable into a section of the keyhole 23 which is configured to support radial loads similar to a journal bearing. A tab 42 connected to a leading end of the pivot shaft 41 is insertable through the keyhole 23 and into the recessed cavity 26. When the key 37 is turned, the tab 42 is pivotally abutted against the annular flange 27 and the inner lock 25 is wedged against the outer cap 15. The resulting wedged combination allows torque to be transferred to the inner lock 25 to effect screwing the inner lock 25 on or off the Schrader valve. The '455 patent is incorporated herein by reference.

While the lock assembly and key system of the '455 patent provided the needed security to greatly reduce the instances of children removing caps off of Schrader valves and inhaling Freon®, the key 37 has proved awkward to use in some installations. Further, it is desirable to carry two keys to fit caps used for two different varieties of Freon®.

### BRIEF SUMMARY OF THE INVENTION

The present invention addresses the above and other needs by providing a combination tool which includes a compact “D” shaped handle and a rotating drum for tool selection. The straight back segment of the “D” provides an axis for rotation of the drum. The drum includes opposed tool ends, either of which may be rotated into position for use. In a preferred embodiment, the tool ends are keys for releasing a tamper resistant cap over a Schrader valve. Each key is shaped for a cap used with a particular Freon® refrigerant used in an air conditioning unit. The drum includes indicia of which Freon® refrigerant the corresponding key matches.

In accordance with one aspect of the invention, there is provided a combination tool. The combination tool includes a handle and a tool carrier. The tool carrier includes a first key shaped to cooperate with a first locking cap, and a second key shaped to cooperate with a second locking cap. The keys are attached to opposite ends of the tool carrier and share a key axis. A tool carrier axis is approximately centered between the keys and approximately orthogonal to the tool axis. A ring handle cooperates with the tool carrier axis wherein the tool carrier may be rotated about the tool carrier axis to position one of the keys for use.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1A is front view of a combination tool according to the present invention.

FIG. 1B is a side view of the combination tool.

FIG. 2 is a perspective view of the combination tool.

FIG. 3 is a perspective view of a tool carrier according to the present invention.

FIG. 4A is a front view of the tool carrier.

FIG. 4B is a side view of the tool carrier.

FIG. 4C is a top view of the tool carrier.

FIG. 4D is a bottom view of the tool carrier.

FIG. 5 is a cross-sectional view of the tool carrier taken along line 5-5 of FIG. 4B.

FIG. 6A is a cross-sectional view of a first tool taken along line 6A-6A of FIG. 4B.

FIG. 6B is a side view of the first tool.

FIG. 6C is a cross-sectional view of a second tool taken along line 6B-6B of FIG. 4B.

FIG. 6D is a side view of the second tool.

FIG. 7A is a front view of a handle according to the present invention.

FIG. 7B is a side view of the handle according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

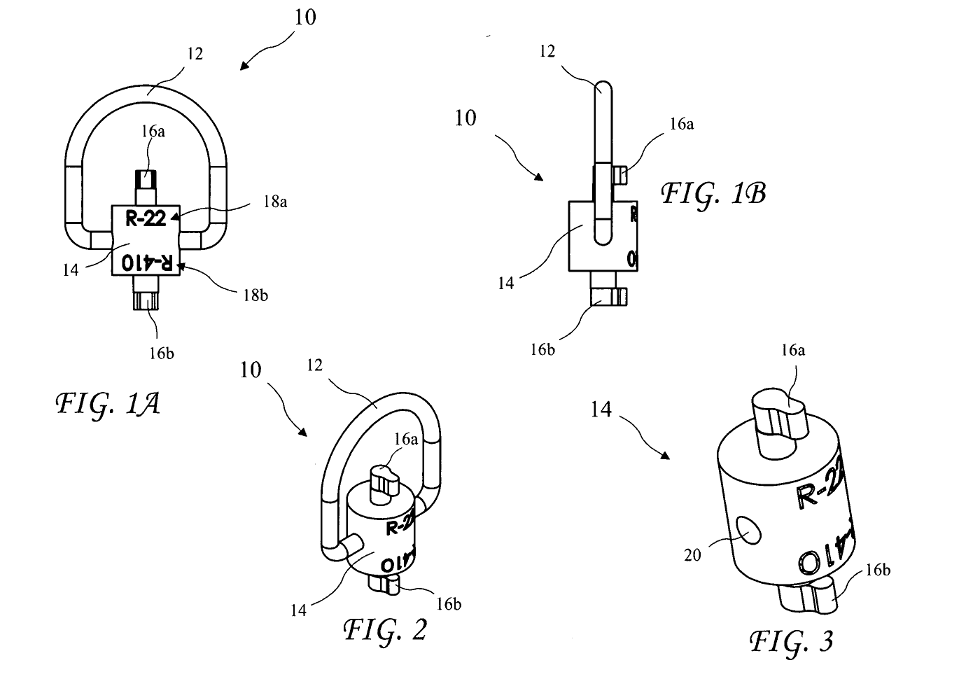

A front view of a combination tool 10 according to the present invention is shown in FIG. 1A, a side view of the combination tool 10 is shown in FIG. 1B, and a perspective view of the combination tool 10 is shown in FIG. 2. The combination tool 10 includes a handle 12 and a tool carrier 14. Tools 16a and 16b reside on opposite ends of the tool carrier 14, and the tool carrier 14 may be rotated with respect to the handle 12 to position one of the tools 16a or 16b for use. Indicia 18a and 18b are provided on the tool carrier 14 to distinguish the use of the tools 16a and 16b respectively.

The combination tool 10 is preferably compact and may easily be carried, for example, in a pocket. Further, unlike screwdriver handles, wrench handles, and other handles used commonly on tools, the handle 12 may easily be turned using a thumb and fingers, and does not require grasping between the finger and palm. As such, the combination tool 10 may be used in tight locations where the size and/or length a typical tool handle would exclude use.

A perspective view of the tool carrier 14 according to the present invention is shown in FIG. 3. The tool carrier 14 is cylindrical, or drum-like, and includes handle receptacles 20 for receiving the handle 12. The tool carrier may also be oval, square, or have an irregular shape, and a combination tool with any shaped tool carrier is intended to come within the scope of the present invention.

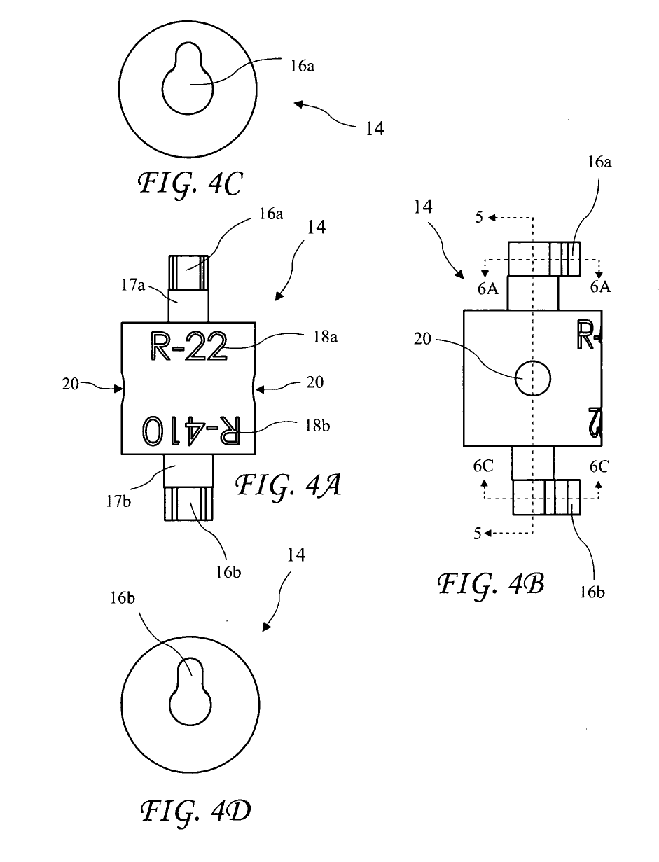

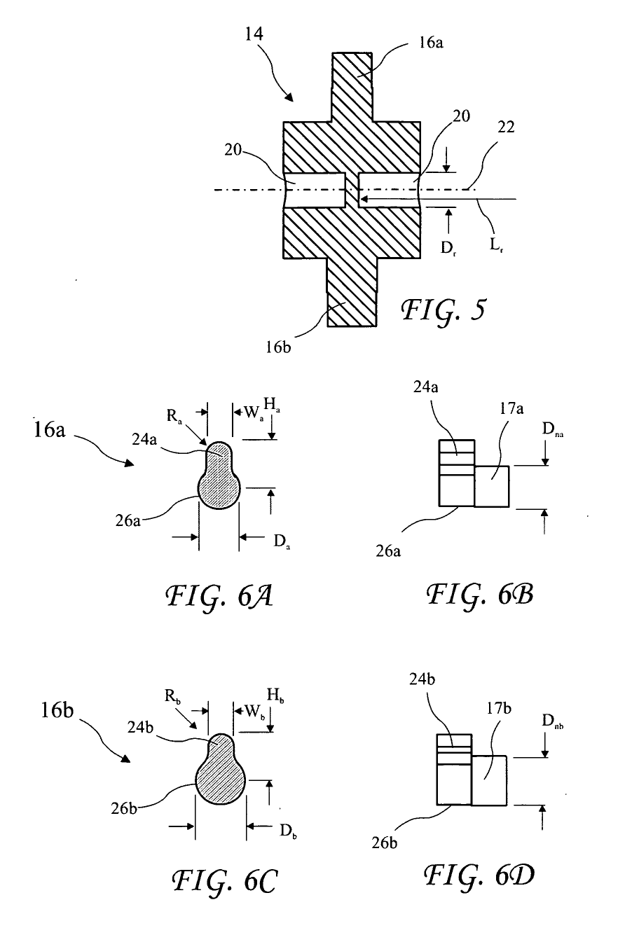

A front view of the tool carrier 14 is shown in FIG. 4A, a side view of the tool carrier 14 is shown in FIG. 4B, a top view of the tool carrier 14 is shown in FIG. 4C, a bottom view of the tool carrier 14 is shown in FIG. 4D, and a cross-sectional view of the tool carrier 14 taken line 5-5 of FIG. 4B is shown in FIG. 5. The indicia 18a and 18b clearly identify the tool in use. In a preferred embodiment the tools 16a and 16b are keys for removing locking caps on Schrader valves. The Schrader valves are used on air condition units to add and remove Freon® refrigerant. Because more than one Freon® refrigerant compound is used in air conditioning units, it is important to identify the particular Freon® refrigerant used in a system being serviced. Adding the wrong Freon® refrigerant compound could damage the unit. Therefore, providing a clear indicia 18a and 18b, provides a check on whether or not the correct Freon® refrigerant compound is being added. In the example shown, the tool 16a is a key for caps used on systems containing R-22 Freon® refrigerant compound, and the tool 16b is a key for caps used on systems containing R-410.

A cross-sectional view of the first tool 16a taken along line 6A-6A of FIG. 4B is shown in FIG. 6A, and a side view of the tool 16a is shown in FIG. 6B. A cross-sectional view of the second tool 16b taken along line 6C-6C of FIG. 4B is shown in FIG. 6C, and a side view of the tool 16b is shown in FIG. 6D. The tools 16a, 16b include noses 24a and 24b having radius Rₐ and R_{b}, which preferably are between approximately 0.044 inches and approximately 0.0455 inches. The noses 24a and 24b further have widths Wₐ and W_{b}, which preferably are between approximately 0.044 inches and approximately 0.0455 inches.

The tools further have base circles 26a and 16b having diameters Dₐ and D_{b}, which Dₐ is preferable approximately 0.143 inches and which D_{b} is preferable approximately 0.177 inches. The first nose 24a extends a height Ha from the center of the base circle 26a, and the second nose 24b extends a height H_{b} from the center of the base circle 26b. The heights Hₐ and H_{b} are preferable between approximately 0.170 inches and 0.173 inches.

The tools 16a and 16b include necks 17a and 17b having diameters Dₙₐ and D_{nb} respectively. The diameter Dₙₐ is preferable between approximately 0.149 inches and approximately 0.151 inches. The diameter D_{nb} is preferable between approximately 0.183 inches and approximately 0.185 inches.

The tool carrier 14 is shown as a cylinder (or drum) having a diameter of approximately ½ inches and a length of ½ inches (ignoring the tools 16a and 16b), and is preferably made from metal. The tool carrier may also be oval, rectangular, or an arbitrary shape. Similarly, the tools may be shaped as needed to cooperate with a locked device.

The tool carrier includes handle receptacles 20 which are approximately centered between the tools 16a and 16b and approximately orthogonal to a tool axis through the tools 16a and 16b. The receptacles 20 are preferably cylindrical with a length Lᵣ and a diameter Dᵣ. The length Lᵣ is preferable approximately 0.225 inches and the diameter Dᵣ is preferably between approximately 0.127 inches and approximately 0.128 inches. Because the tools are not cylindrical, the tool axis may be any line running through both tools or nearly running through both tools, and is not a precise axis running through the centers of both tools.

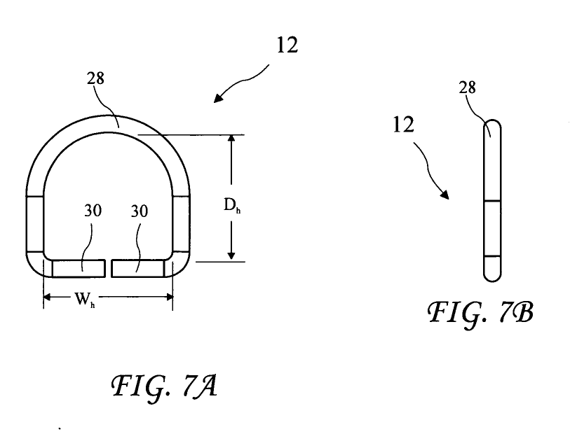

A front view of the handle 12 according to the present invention is shown in FIG. 7A and a side view of the handle 12 is shown in FIG. 7B. The handle 12 includes an arched portion 28 and axles 30. The axles 30 cooperate with handle receptacles 20 (see FIG. 5) to attach the handle to the tool carrier 14. The arched portion 28 may be rounded, squared off, or have an irregular shape, and may be any shape which may easily be turned using a thumb and fingers, and does not require grasping between the finger and palm. The handle 12 is preferably made from ⅛ inch spring wire, and preferably has a handle height Hₕ of approximately 1.19 inches and a handle width Wₕ of approximately 1.19 inches. The height handle Hₕ and width Wₕ may be somewhat varied with a lower limit leaving sufficient room to pivot a tool carrier in the handle, and an upper limit retaining the compact nature of the combination tool, for example, a height of two inches and a width of two inches.

While the invention herein disclosed has been described by means of specific embodiments and applications thereof, numerous modifications and variations could be made thereto by those skilled in the art without departing from the scope of the invention set forth in the claims.

I claim:

1. A combination tool comprising:
a drum;
two opposing tools attached to the drum and sharing a tool axis;
a drum axis approximately centered between the tools and approximately orthogonal to the tool axis;
a ring handle cooperating with the drum axis wherein the drum may be rotated about the drum axis to position one of the tools for use.

2. The combination tool of claim 1, wherein the ring handle comprises:
a handle width (Wₕ) sufficient to apply torque to the tool positioned for use; and
a handle depth (Dₕ) sufficient to allow the drum and tools to be rotated around the drum axis.

3. The combination tool of claim 1, wherein the handle width is approximately equal to the handle depth.

4. The combination tool of claim 1, wherein the ring handle is formed from metal rod having a diameter between approximately one eight inch and approximately one quarter inch.

5. The combination tool of claim 4, wherein the ring handle is formed from metal rod having a diameter of approximately one quarter inch.

6. The combination tool of claim 1, wherein the ring handle is formed from spring wire.

7. The combination tool of claim 6, wherein:
the drum includes two opposing handle receptacles coaxial with the drum axis; and
the ring handle includes axles rotatably residing in the handle receptacles.

8. The combination tool of claim 1, wherein;
the tools comprise a first tool and a second tool;
the first tool is a first key shaped to cooperate with a first rotationally operated article; and
the second tool is a second key shaped to cooperate with a second rotationally operated article.

9. The combination tool of claim 8, wherein:
the first rotationally operated article is a first locking cap; and
the second rotationally operated article is a second locking cap.

10. The combination tool of claim 9, wherein:
the caps are configured to reside on valves used to add and remove a Freon® refrigerant from an air conditioning unit;
the first locking cap corresponds to a first Freon® refrigerant; and
the second locking cap corresponds to a second Freon® refrigerant.

11. The combination tool of claim 10, wherein the drum includes indicia of the Freon® refrigerant which each key corresponds to.

12. A combination tool comprising:
a tool carrier;
a first key attached to the tool carrier, the first key shaped to cooperate with a first locking cap;
a second key attached to an opposite end of the tool carrier and sharing a key axis, the second key shaped to cooperate with a second locking cap;
a tool carrier axis approximately centered between the keys and approximately orthogonal to the tool axis;
a ring handle cooperating with the tool carrier axis wherein the tool carrier may be rotated about the tool carrier axis to position one of the keys for use.

13. The combination tool of claim 12, wherein:
the caps are configured to reside on valves used to add and remove a Freon® refrigerant from an air conditioning unit;
the first locking cap corresponds to a first Freon® refrigerant; and
the second locking cap corresponds to a second Freon® refrigerant.

14. The combination tool of claim 13, wherein the drum includes indicia of the Freon® refrigerant which each key corresponds to.

15. A combination tool comprising:
a tool carrier;
a first key attached to the tool carrier, the first key shaped to cooperate with a first locking cap configured to reside on a Schrader valve used to add and remove a first Freon® refrigerant from an air conditioning unit;
a second key attached to an opposite end of the tool carrier and sharing a key axis, the second key shaped to cooperate with a second locking cap configured to reside on the Schrader valve used to add and remove a second Freon® refrigerant from an air conditioning unit;
a tool carrier axis approximately centered between the keys and approximately orthogonal to the tool axis;
a handle cooperating with the tool carrier axis wherein the tool carrier may be rotated about the tool carrier axis to position one of the keys for use, wherein the handle includes indicia of the Freon® refrigerant which each key corresponds to.
